(19) United States
(12) Patent Application Publication
(10) Pub. No.: US 2003/0009563 A1
(43) Pub. Date: Jan. 9, 2003

(54) Method for client-side inclusion of data elements

(75) Inventors: Frederick Douglis, Basking Ridge, NJ (US); Michael Rabinovich, Gillette, NJ (US); Zhen Xiao, Randolph, NJ (US)

Correspondence Address: AT&T CORP., P.O. BOX 4110, MIDDLETOWN, NJ, 07748, US

(73) Assignee: AT&T Corp., New York, NY (US)

(21) Appl. No.: 10/063,120

(22) Filed: Mar. 22, 2002

Related U.S. Application Data
(63) Continuation-in-part of application No. 09/421,116, filed on Oct. 19, 1999.
Application No. 09/421,116 is a continuation of application No. 08/982,308, filed on Dec. 1, 1997, now Pat. No. 6,021,426.
(60) Provisional application No. 60/054,366, filed on Jul. 31, 1997.

(51) Int. Cl. G06F 15/16

(52) U.S. Cl. 709/227; 709/218

(57) ABSTRACT

The present invention is directed to a mechanism that permits a browser to assemble content dynamically from cached static elements and dynamic elements retrieved from a data network.

### CROSS REFERENCE TO RELATED APPLICATIONS

This application claims priority to and is a continuation-in-part application of United States Utility Patent Application “METHOD AND APPARATUS FOR DYNAMIC DATA TRANSFER,” Ser. No. 09/421,116, filed on Oct. 19, 1999, which claims priority to Ser. No. 08/982,308, filed on Dec. 1, 1997, issued on Feb. 1, 2000 as U.S. Pat. No. 6,021,426, which claims priority to U.S. Provisional Patent Application, Serial No. 60/054,366, filed on Jul. 31, 1997, the contents of which are incorporated by reference herein.

### COPYRIGHT STATEMENT

A portion of the disclosure of this patent document contains material which is subject copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF INVENTION

The present invention relates to mechanisms for optimizing the distribution of dynamic and static content across a data network.

Data networks, such as packet-switched networks based on the TCP/IP protocol suite, can be utilized to distribute a rich array of digital content to a variety of different client applications. Popular today on data networks such as the Internet are browsing applications for searching the World Wide Web, e.g. Mozilla, Opera, Netscape Navigator, or Microsoft Internet Explorer, which utilize the HyperText Transfer Protocol (HTTP) to retrieve data objects such as documents written in the HyperText Markup Language (HTML) along with embedded content. See, e.g., R. Fielding et al., “Hypertext Transfer Protocol—HTTP/1.1,” Internet Engineering Task Force (IETF), Request for Comments (RFC) 2616 Network Working Group, 1999, which is incorporated by reference herein. Browsing applications have developed sophisticated built-in scripting capabilities, typically based on the popular JavaScript scripting language (see, e.g., D. Flannagan, “JavaScript: The Definitive Guide,” Second Edition, O'Reilly & Associates, January 1997), as well as the ability to execute embedded programming objects such as Java applets or ActiveX objects.

Most Web pages are composed of content that changes often, such as stock quotes, and content that changes infrequently, such as the title and basic format of the document. It is often advantageous to separate such “dynamic” and “static” content for caching purposes, so that the dynamic portion can be retrieved from a server without having to re-request the unchanged static portion as well. See U.S. Pat. No. 6,021,426 to Douglis et al., which is incorporated by reference herein. This serves to reduce network congestion, as well as processing overhead on origin servers. This idea was first suggested by the technique referred to in the art as “delta encoding”, where cache entries are updated by transferring only the difference (i.e. the “delta”) between the cached entry and the current version of the data object. See, e.g., U.S. Pat. No. 5,931,904, to Banga et al., which are incorporated by reference herein. The issue of how to handle the distribution of dynamic content on the Internet has generated a number of possible solutions, such as cached programming objects that mimic the dynamic behavior of the origin server (see, e.g., www.pivia.com), and elaborate distributed programming environments that utilize proprietary programming languages and specialized client development environments (see, e.g., www.curl.com). See also C. Brabrand et al., “The <bigwig>Project”, BRICS, Dept. of Computer Science, University of Aarhus, Denmark, http://wwww.brics.dk/bigwig/, which specifies a higher-order Web service programming language to express how to dynamically contruct HTML documents.

More recently, an XML-based markup specification called “Edge Side Includes” (“ESI”) has been defined which provides a means for assembling included content, using an XML template as a container with instructions for the retrieval and inclusion of separate resources referred to as fragments. See M. Tsimelzon et al., “ESI Language Specification 1.0,” http://www.esi.org/language_spec_{—}1-0.html, which is incorporated by reference herein. ESI is primarly intended for processing on surrogates or “reverse proxies” at the edge of a network. See M. Nottingham et al., “Edge Architecture Specification,” http://www.esi.org/architecture_spec_{—}1-0.html, which is incorporated by reference herein. Although ESI thereby optimizes the communication between the reverse proxy and an origin server, the proxy still needs to assemble the components into a single HTML page before sending it to the client browser. Accordingly, the bandwidth between the end user and the reverse proxy may still be wasted due to unnecessary download of contents that are otherwise cacheable.

### SUMMARY OF INVENTION

The present invention is directed to a mechanism that permits a browser to assemble content dynamically from cached static elements and dynamic elements retrieved from a data network. In accordance with an aspect of the invention, the browser retrieves and caches a template and parses the template for references to included objects. The browser retrieves the included objects and assembles them into a complete data page that is presented to the user. Subsequent data requests require retrieval of only the included objects, while the cached template is reused. In accordance with an embodiment of the invention, the browser is first directed to a wrapper document that contains a scripting program that performs the template retrieval and inclusion processing. The present invention advantageously permits the browser to cache the wrapper program, the template, and the included objects independently. By providing static content in a cached template and dynamic content in included elements, it is possible to efficiently generate the data page and minimize bandwidth demands from the clients while ensuring that the data is up-to-date. The process of building the data page is largely transparent to the end user and can be accomplished even where the browser does not explicitly provide support for general inclusion.

These and other advantages of the invention will be apparent to those of ordinary skill in the art by reference to the following detailed description and the accompanying drawings.

### BRIEF DESCRIPTION OF DRAWINGS

FIG. 1 is an abstract diagram of interaction between a client browser and a content server, in accordance with a preferred embodiment of the invention, wherein a wrapper page is downloaded to the browser.

FIG. 2 is a flowchart of processing performed by a scripting program contained in the wrapper page, in accordance with a preferred embodiment of the invention.

FIG. 3 is an abstract diagram of interaction between a client browser and one or more content servers, in accordance with a preferred embodiment of the invention, wherein the scripting program causes the download of a template and one or more included objects.

FIG. 4 is an abstract diagram of interaction between a client browser and a content server, in accordance with a preferred embodiment of the invention, wherein the browser cache stores the scripting program, the template, the included objects and the browser downloads updated included objects.

FIG. 5 is an example of a template with various inclusion markups.

### DETAILED DESCRIPTION

The following preferred embodiment is described, in particular and without limitation, from the perspective of a browser application such as Microsoft's Internet Explorer. Internet Explorer is the most popular browser today and is expected to occupy a significant fraction of the browser market for the foreseeable future. The following implementation has been designed to provide a solution that is as widely applicable as possible.

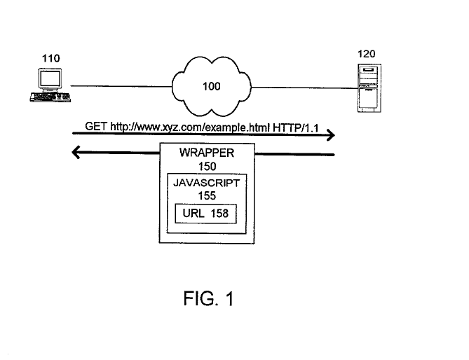

FIG. 1 is an abstract diagram of the interaction between the client browser 110 and a content server 120, such as a Web server, in accordance with a preferred embodiment of an aspect of the invention. When a user enters a URL pointing to content served by server 120, the client browser 110 issues an HTTP GET request to the server 120, as shown in FIG. 1. Rather than serving the content directly, the server 120 responds by sending a small “wrapper” page 150 that contains a scripting program 155 and a URL 158 pointing to a template. The wrapper page 150 can be a conventional HTML document containing a scripting program 155 written in an advantageous scripting language such as JavaScript. The client browser 110 caches the wrapper page 150 and begins to process the contents of the wrapper page 150. Upon reading the scripting program 155, the client browser 110 automatically commences execution of the JavaScript program.

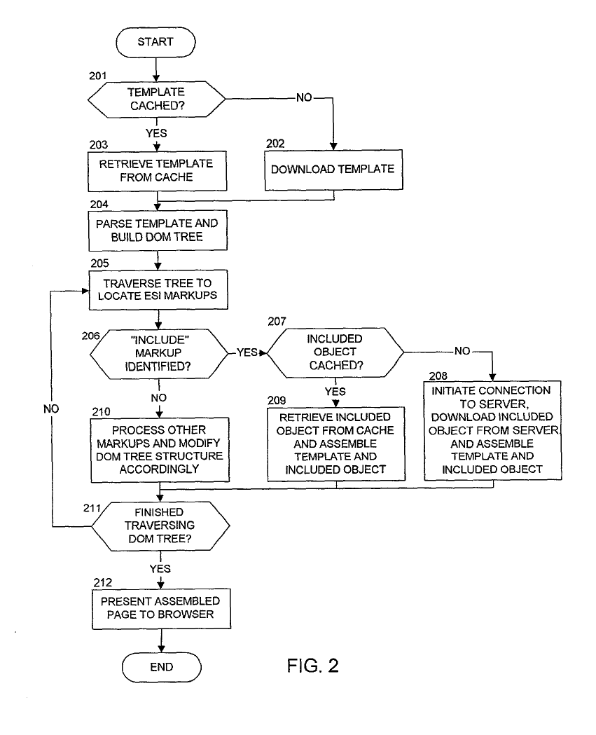

FIG. 2 is a simplified flowchart of the processing performed by the scripting program 155 contained in the wrapper page 150, in accordance with a preferred embodiment of the invention. The scripting program first attempts to retrieve a template. The template is written in an advantageous markup language, such as XML. See, e.g., “Extensible Markup Language (XML) 1.0,” World Wide Web Consortium (W3C), REC-xml-19980210, February 1998, http://www.w3.org/TR/1998/REC-xml-19980210, which is incorporated by reference herein. At step 201, the client browser's cache is checked to see whether it contains the template. If not, then at step 202 the template is downloaded, for example using ActiveX. If a fresh copy of the template is cached, then the scripting program retrieves the template from the cache at step 203. At step 204, the scripting program parses the template and builds a document object model (DOM) tree dynamically. See, e.g., “Document Object Model (DOM) Level 1 Specification,” World Wide Web Consortium (W3C), REC-DOM-Level-1-19981001, October 1998, http://www.w3.org/TR/REC-DOM-Level-1/, which is incorporated by reference herein. The document object model provides a programming interface that permits the scripting program to navigate the structure of the template and add, modify, or delete elements and content. At step 205, the scripting program traverses the tree to locate inclusion markups. The inclusion markups are preferably written in an advantageous inclusion markup language such as ESI. See M. Tsimelzon et al., “ESI Language Specification 1.0,” http://www.esi.org/language_spec_{—}1-0.html, which is incorporated by reference herein. If the scripting program identifies an include element, at step 206, then the scripting program attempts to retrieve the required data object fragment for assembly. At step 207, the browser cache is checked to see whether it contains the required data object fragment. If not, then at step 208, the scripting program processes the include element by attempting to establish a connection to the relevant server and retrieving the required data object fragment. In the context of Internet Explorer, this again can be accomplished using ActiveX. The retrieved data object, typically another XML file, is then assembled into the template. Where a copy of the data object is in the browser cache and is not stale, then at step 209, the data object fragment is retrieved from the cache and then assembled into the template. Where the scripting program identifies another type of inclusion markup, such as a conditional element, at step 210, the scripting program proceeds to process the markup and modify the DOM tree structure accordingly. At step 211, the scripting program continues to process the inclusion markups until the scripting program is finished traversing the entire DOM tree. Then, at step 212, the scripting program takes the assembled components and presents the resulting page which is then displayed in the browser application.

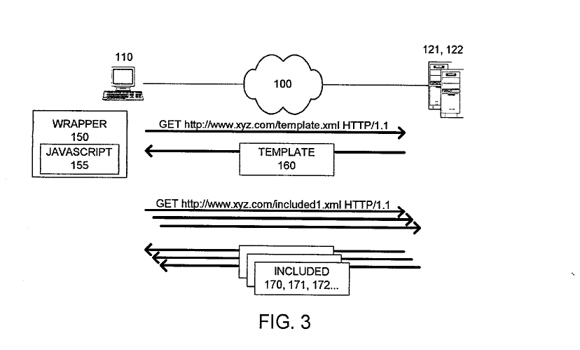

FIG. 3 illustrates the retrieval and caching process of the separate components. The client browser 110, in accordance with the scripting program, first retrieves the XML template 160 from a content server 121. This corresponds to step 202 in FIG. 2. Then, after processing the template 160, the client browser 110 retrieves the different included objects 170, 171, 172, . . . etc. from one or more content servers 122. This corresponds to step 208 in FIG. 2. It should be noted that the content server 120 that stores the original wrapper page 150 can be the same server as the server(s) 121, 122 that handles requests for the template 160 and the included objects 170, 171, 172, . . . etc. Alternatively, the requests for the different elements can be distributed among different servers in a manner advantageous to the content provider. Since the different elements—namely the wrapper page 150 with its JavaScript program 155, the XML template 160, and the included objects 170, 171, 172—can all be cached by the browser 110, notably with different cache control parameters, the perceived end-user performance can be substantially improved if the dynamic content in the included components only constitutes a small fraction of the resulting page.

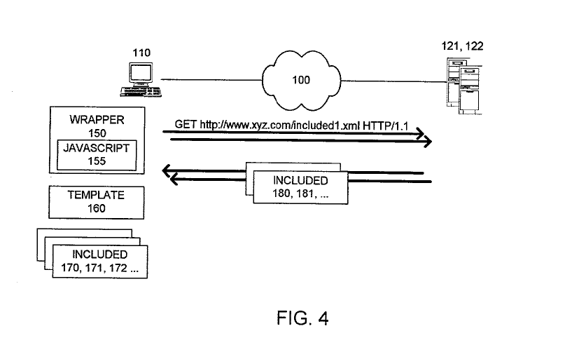

FIG. 4 illustrates the retrieval of updated versions of the content. The client browser 110 already has within its cache the wrapper 150 containing the JavaScript program 155, the template 160, and the included objects 170, 171, 172, etc.—one or more of which are now out-of-date in accordance with their cache control parameters. The client browser 110 retrieves the unexpired wrapper 150 from its cache and begins to execute the JavaScript program 155 again. The browser 110 continues, as described above and in FIG. 2, to retrieve the template 160 from its cache and any other included objects 170, etc., that have not expired. The client 110 then issues an HTTP GET request for only the cached included objects that have expired, namely the included objects 180, 181, etc. As stated above, assuming these included objects 180, 181, . . . , etc. constitute a small fraction of the resulting page, this can result in a substantial reduction in the amount of bandwidth utilized and in the perceived user latency.

Note that there is a performance penalty when the user first visits the particular site as illustrated by FIG. 1-3. Since the JavaScript program, the template, and all fragment pages have to be retrieved independently, this technique may cause a noticeable slow-down due to TCP three-way handshakes required to establish TCP connections needed for the separate HTTP requests. Nevertheless, this penalty can be mitigated if HTTP/1.1 persistent connections and pipelining are widely supported. Also, it is possible to cache and reuse the same scripting program for many different data pages and different origin servers.

An example program listing including relevant portions of a scripting program written in JavaScript for Internet Explorer is attached hereto. As described above in detail, the JavaScript program is capable of parsing ESI tags and takes advantage of ActiveX when a necessary resource must be retrieved from the data network. The JavaScript may be readily embedded in an HTML wrapper page, as is well-known in the art.

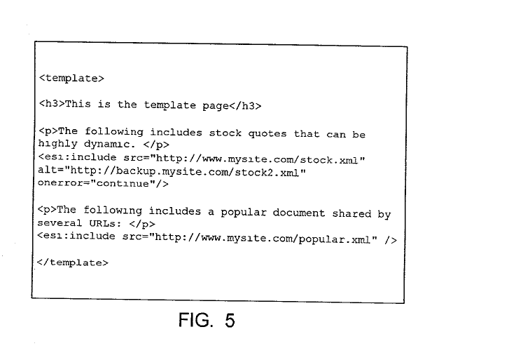

FIG. 5 shows an example of an XML template that contains some ESI inclusion markups, that illustrates the flexibility of the above implementation when utilized with an inclusion markup language such as ESI. The stock quotes, which are expected to change rapidly, are provided as an included xml element. An ESI include markup shows that the included object, namely the file “stocks.xml” can be retrieved from the URI http://www.mysite.com/stock.xml. The ESI language specification also permits alternative URIs to be specified, in case the browser cannot retrieve the resource from the URI indicated by the src attribute. In FIG. 5, the ESI markup specifies an alternative URI of http://backup.mysite.com/stock2.xml. Note also that the markup includes the onerror attribute. This means that the browser will delete the included element silently rather than issue an HTTP error code. Notably, and not shown in FIG. 5, an ESI include markup can also specify inclusion based on environmental variables or cookie values, if desired by the content provider. The instant implementation is highly compliant with the ESI proposed standard. (The only exception is the inline element which would require the browserJavaScript implementation to have complete control over the underlying caching structure, which is not possible with current browser applications).

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. For example, the detailed description describes a preferred embodiment of the invention with particular reference to XML, ESI, JavaScript and ActiveX. However, the principles of the present invention could be readily extended to other technologies.

The scripting program could have readily been implemented by one of ordinary skill in the art in a programming language such as Java. The inventors see a Java implementation as not being preferable since many users disable Java for security reasons. Nevertheless, such an extension could be readily implemented by one of ordinary skill in the art given the above disclosure. Similarly, the above-described implementation uses ActiveX to retrieve Web objects. An analogous system that could be utilized on a browser such as Netscape Navigator would take advantage of a technology such as LiveConnect to implement this feature. Also, a different inclusion mechanism other than ESI could be utilized, such as the general inclusion framework described in “Xinclude.” “XML Inclusions (Xinclude) Version 1.0,” W3C Working Draft, May 2001, http://www.w3c.org/TR/xinclude, which is incorporated by reference herein. Unfortunately, no major browser at this current moment supports xinclude; moreover, xinclude currently does not provide the exception handling capability specified in inclusion markup languages such as ESI, e.g. including an alternate document where the original document is unavailable. Nevertheless, assuming proper xinclude support were provided in a browser, xinclude could be readily utilized as the basis for an alternative to ESI.

Program Listing Deposit

function createException(msgText) {

this.msgText = msgText ;

}
function load_xml(src, alt) {

// document.write(“<BR>load_xml(”, src, “, ”, alt, “)<BR>”) ;
var xmldoc = new ActiveXObject(“Microsoft.XMLDOM”) ;
xmldoc.async = false ;
xmldoc.load (src) ;
if (xmldoc.parseError.errorCode == 0) {

return (xmldoc.documentElement) ;

}
if (alt == null) { return(null) }
xmldoc = new ActiveXObject(“Microsoft.XMLDOM”) ;
xmldoc.async = false ;
xmldoc.load(alt) ;
if (xmldoc.parseError.errorcode == 0) {

return(xmldoc.documentElement) ;

}
return(null) ;

}
function report_error(text) {

document.write (“<BR><FONT COLOR=‘red’>”, text, “</FONT><BR>”) ;
}
function print_tree (node) }

document.write(node.nodeName, “<BR>”) ;
if (node.childNodes.length == 0) { return }
for (var i=0; i<node.childNodes.length; i++)

print_tree(node.childNodes(i)) ;

}

}
function handle_include (node) {

var parent = node.parentNode ;
if (parent == null) {

report_error(“Error: the parent node of ‘include’ element is null.”)
return ;

}
var srcItem = node.attributes.getNamedItem(“src”) ;
var altItem = node.attributes.getNamedItem(“alt”) ;
var onerrorItem = node.attributes.getNamedltem(“onerror”) ;
var src = alt onerror = null
if (srcItem = null) {

report_error(“Error: the ‘include’ element must specify ‘src’ attribu
return ;

}
src = srcItem.value ;
if (altItem) { alt = altltem.value }
if (onerrorItem) { onerror = onerrorItem.value }
var newNode = load_xml(src, alt) ;
if (newNode) {

// can we ‘iterate’ after ‘replaceChild’?
iterate(newNode) ;
parent.replaceChild(newNode, node) ;

} else if (onerror == “continue”) {

parent.removeChild(node) ;

} else {

var err_msg = “Error: the ‘include’ element cannot load “+ src ;
if (alt) { err_msg = err_msg + “or ” + alt + “in the ‘include’ elem
includeException = new createException(err_msg) ;
throw includeException ;

}
return ;

}
function handle_choose(node) {

var parent = node.parentNode ;
if (parent == null) {

report_error(“Error: the parent node of ‘choose’ element is null.”) ;
return ;

}
var num_when = num_otherwise = 0
var child = node.firstChild ;
while (child) {

if (child.nodeName == “esi_when”) { num_when++; }
else if (child.nodeName == “esi_otherwise”) { num_otherwise++; }
else }
report_error(“Error: the ‘choose’ element can only have ‘when’ and
return ;
}
child = child.nextSibling ;

```
}
if (num_when == 0) {
  report_error(“Error: the ‘choose’ element must have at least one ‘whe
return ;
}
if (num_otherwise > 1) {
  report_error(“Error: the ‘choose’ element can have at most one ‘other
return ;
}
var child = node.firstChild ;
while (child) {
```

var nextChild = child.nextSibling ;
if (child.nodeName == “esi_when”) {

var testItem = child.attributes.getNamedItem(“test”) ;
if (testItem == null) {

report_error(“Error: the ‘when’ element must have ‘test’ attribute.”) ;
return ;

}
// should catch exception here. Also < may cause problems
if (eval(testItem.value)) {

// can we “iterate” after ‘replaceChild’ ?

// should replace the otherwise node to “DIV”

iterate(child) ;
parent.replaceChild (child, node) ;
// should we also free the rest nodes?
return ;

} else {

node.removeChild(child) ;

}

}
child = nextChild ;

}
var child = node.firstChild ;
while (child) }

if (child.nodeName == “esi_otherwise”) {

// can we “iterate” after ‘replaceChild’?
// should replace the otherwise node to “DIV”
iterate(child) ;
parent.replaceChild(child, node) ;
return ;

}
child = nextSibling ;

}
parent.removeChild(node)
return ;

}
function handle_try(node) {

var parent = node.parentNode ;
if (node.childNodes.length != 2) {

report_error(“Error: the ‘try’ element must contain exactly one insta
return ;

}
var attemptNode = node.childNodes(0) ;
var exceptNode = node.childNodes(1) ;
if (attemptNode.nodeName != “esi_attempt” || exceptNode.nodeName != “es

report_error(“Error: the ‘try’ element can only include ‘attempt’ and
return ;

}
try {
iterate (attemptNode) ;
node.removeChild(exceptNode) ;
parent.replaceChild(attemptNode, node) ;
return ;

} catch (exceptionoObi) {

if (exceptionObj instanceof createException) {

iterate(exceptNode) ;
node.removeChild(attemptNode) ;
parent.replaceChild (exceptNode, node) ;
return ;

} else {

throw exceptionObj ;

}

}
return ;

}
function iterate(node) {

if (node.childNodes.length == 0) { return }
var child = node.firstChild ;
while (child) {

document.write(child.nodeName, “<BR>”) ;
var next = child.nextSibling ;
switch (child.nodeName) {

case “esi_include”:

handle_include(child) ;
break ;

case “esi_choose”:

handle_choose(child)
break ;

case “esi_try”:

handle_try(child) ;
break ;

case “esi_comment”:

// should find a better way to test whether an element has an
// end tag. Current tests think <esi:comment></esi:comment> is 1

if(child.firstChild) {

report_error(“Error: the ‘comment’ element must not have an end tag”)

}

node.removeChild (child) ;

break ;

case “esi_remove”:

node.removeChild(child) ;

break ;

case “#comment”:

/* should handle this before DOM tree is built */

var comment = child.nodeValue ;
if(/\hat{ }esi\b/.test(comment)) {

comment = comment.replace(/\hat{ }esi\b/, “”) ;
comment = “<DIV>” + comment + “</DIV>” ;
var newChild = new ActiveXObject(“Microsoft.XMLDOM”) ;
newChild.async = false ;
newChild.loadXML (comment) ;
if(newChild.parseError.errorcode == 0) {

iterate(newChild.documentElement) ;
node.replaceChild(newchild.documentElement, child) ;

} else {

report_error(“Error: content inside <--esi --> is not valid XML”) ;

break ;

}
break ;

default:
iterate(child) ;

break ;

}
child = next ;

}

}

1. A method of operating a browser application with a connection to a data network comprising:
(a) retrieving a template containing one or more inclusion markups;
(b) parsing the template for the inclusion markups;
(c) retrieving from a server connected to the data network an included data object identified in an inclusion markup;
(c) assembling the template and the included data objects to create a data page that can be displayed to the user.

2. The invention of claim 1 wherein the template is retrieved from a cache.

3. The invention of claim 1 wherein the inclusion markup identifying the included data object also identifies at least one alternative source for the included data object.

4. The invention of claim 1 wherein the template and the data objects are expressed in XML.

5. The invention of claim 1 wherein the template is used to create a document object model tree.

6. The invention of claim 5 wherein the document object model tree is modified in accordance with the inclusion markups.

7. The invention of claim 1 wherein the inclusion markups are expressed using ESI.

8. A device-readable medium storing a scripting program for performing a method of operating a browser application with a connection to a data network, the method comprising the steps of:
(a) retrieving a template containing one or more inclusion markups;
(b) parsing the template for the inclusion markups;
(c) retrieving from a server connected to the data network an included data object identified in an inclusion markup;
(c) assembling the template and the included data objects to create a data page that can be displayed to the user.

9. The invention of claim 8 wherein the template is retrieved from a cache.

10. The invention of claim 8 wherein the inclusion markup identifying the included data object also identifies at least one alternative source for the included data object.

11. The invention of claim 8 wherein the template and the data objects are expressed in XML.

12. The invention of claim 8 wherein the template is used to create a document object model tree.

13. The invention of claim 12 wherein the document object model tree is modified in accordance with the inclusion markups.

14. The invention of claim 8 wherein the inclusion markups are expressed using ESI.
